(19) United States
(12) Patent Application Publication
(10) Pub. No.: US 2020/0329531 A1
(43) Pub. Date: Oct. 15, 2020

(54) HEATING APPARATUS COMPRISING A BATTERY AND A POWER INVERTER FOR INTRODUCING ENERGY FROM THE BATTERY TO THE ELECTRIC SUPPLY DEVICE

(71) Applicant: LANCEY ENERGY STORAGE, GRENOBLE (FR)

(72) Inventors: Raphaël MEYER, GRENOBLE (FR); Gilles MOREAU, GRENOBLE (FR); Pierre SCHEFLER, PAJAY (FR); Benjamin KOSICKI, GRENOBLE (FR)

(21) Appl. No.: 16/765,433

(22) PCT Filed: Oct. 10, 2018
(86) PCT No.: PCT/FR2018/052516

§ 371 Date: May 19, 2020

(30) Foreign Application Priority Data
Nov. 20, 2017 (FR) 17/60912

(51) Int. Cl. H05B 1/02; F24C 7/00; F24C 15/08

(52) U.S. Cl. CPC H05B 1/0277; F24C 15/08; F24C 7/002

(57) ABSTRACT

A heating apparatus including a storage device and at least one heater member. The heater member can be connected to the storage device and an electric power supply source. An inverter is connected to the output of the storage device and the electrical supply source. First switching elements are used to vary the first connection elements between an open circuit configuration and a closed circuit configuration in which electrical energy stored in the storage device is injected into the electrical supply source via the inverter.

### CROSS REFERENCE TO RELATED APPLICATIONS

This application is a National Stage of PCT Application No. PCT/FR2018/052516 filed on Oct. 10, 2018, which claims priority to French patent application FR17/60912 on filed on Nov. 20, 2017 the contents each of which are incorporated herein by reference thereto.

### TECHNICAL FIELD

The present invention concerns an electrical radiator type heating apparatus having a case containing an electric power storage device, first linking elements to allow linking the electric power storage device to an electric power supply source external to the apparatus, at least one heater member producing a flow of calories when an input of the heater member is supplied by an electric voltage, second linking elements to allow linking the input of the heater member to an output of the electric power storage device and third linking elements to allow linking the input of the heater member to the electric power supply source.

The invention also concerns an electrical installation comprising an electric power supply source delivering an electric voltage and at least one such heating apparatus.

### BACKGROUND

Conventionally, the electric power supply source, to which the heating apparatus is connected, delivers an alternating electric voltage. This is typically the local electrical network.

In some heating apparatus, it is also known to integrate an electric power storage device, typically in the form of a battery pack. This allows storing the energy used by the heater member, in order to space the consumption of electricity over time.

The heater member can be supplied directly by the electric power supply source and/or by the electric power storage device, said electric power storage device being, in turn, recharged by the electric power supply source.

In parallel, there are many renewable energy based electric power supply sources capable of delivering a direct electric voltage, typically photovoltaic panels, fuel cells, supercapacitors, batteries based on an assembly of electrochemical cells.

The current trend provides that the electrical installation of the dwellings are based on a variety of electric power supply sources, typically mixing alternating voltage sources and direct voltage sources to include a local production of electricity, the assembly being controlled by an energy management system also known by the acronym EMS.

In the current state of knowledge, the electrical heating apparatus cannot actively participate in the thermal management of the building: the type of the electricity, the monitoring and the storage capacity of the heating apparatus are limited (alternating current, wired management, thermal inertia storage). Generally, the conventional energy management system using conventional electrical radiators cannot participate in the integration of renewable energies on the electrical network.

### BRIEF SUMMARY

The present invention aims at solving all or part of the drawbacks presented above.

In this context, an objective is to provide a heating apparatus that can be directly used in an energy management system.

This objective can be achieved thanks to providing an electrical radiator type heating apparatus having a case containing an electric power storage device, first linking elements to allow linking the electric power storage device to an electric power supply source external to the apparatus, at least one heater member producing a flow of calories when an input of the heater member is supplied by an electric voltage, second linking elements to allow linking the input of the heater member to an output of the electric power storage device and third linking elements to allow linking the input of the heater member to the electric power supply source, in which the first linking elements comprise first connecting elements linking the output of the electric power storage device to the electric power supply source, the first connecting elements comprising:
an inverter housed in the case, an input of which is connected to the output of the electric power storage device and an output of which is capable of being linked to the electric power supply source,
and first switching elements to vary the first connecting elements between an open circuit configuration and a closed circuit configuration in which the electric power stored in the electric power storage device is injected into the electric power supply source via the inverter.

Such a heating apparatus has the advantage of allowing reinjecting, in the form of an alternating current, a certain amount of electric power, stored in the electric power storage device thereof, to an electric power supply source operating under alternating voltage, typically the local electrical network, to participate in the energy management. Its integration into an energy management system of a building is greatly facilitated.

The heating apparatus can also meet the technical characteristics presented below, taken alone or in combination.

The inverter comprises heat sinks producing a second flow of calories with the calories generated by the inverter and the second flow is mixed with the first flow of calories generated by the heater member.

The first linking elements comprise second connecting elements linking an input of the electric power storage device to the electric power supply source, said second connecting elements comprising, on the one hand, a voltage converter housed in the case and having an input supplied by the electric power supply source and an output linked to the input of the electric power storage device, on the other hand, second switching elements to vary the second connecting elements between an open circuit configuration and a closed circuit configuration in which the electric power from the electric power supply source is injected into the electric power storage device via the voltage converter.

The voltage converter comprises heat sinks producing a third flow of calories with the calories generated by the voltage converter and the third flow is mixed with the first flow of calories generated by the heater member.

The voltage converter and the inverter are constituted by the same and single bidirectional electrical system.

The third linking elements comprise linking elements between the output of the voltage converter and the input of the heater member.

The heating apparatus comprises a management unit housed in the case and controlling at least the heater member and the first switching elements and/or linking elements directly linking the input of the heater member to the electric power supply source.

The management unit ensures a control of the second switching elements, third switching elements to vary the second linking elements between a closed circuit configuration and an open circuit configuration, and fourth switching elements to vary the third linking elements between a closed circuit configuration and an open circuit configuration.

The heating apparatus comprises communication elements housed in the case allowing the management unit to be able to communicate with at least one communicating device of an energy management system of the building in which the heating apparatus is implanted.

### BRIEF DESCRIPTION OF THE DRAWINGS

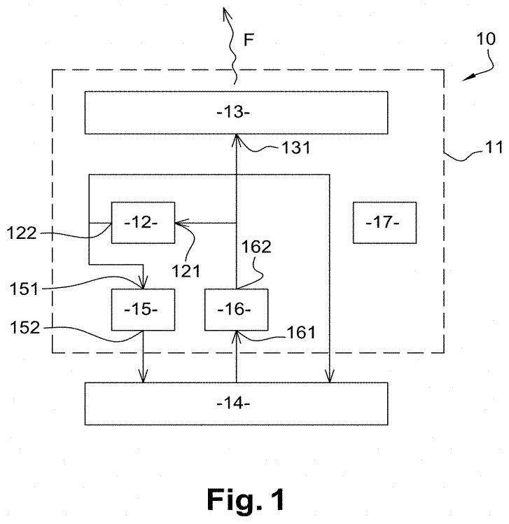

The invention will be even better understood using the following description of particular embodiments of the invention given by way of non-limiting examples and represented in the single FIG. 1 which illustrates a schematic view of the components of an example of a heating apparatus according to the invention.

### DETAILED DESCRIPTION

With reference to the appended single FIG. 1, as briefly presented above, the invention essentially concerns an electrical radiator type heating apparatus 10 having a case 11 containing an electric power storage device 12 capable of receiving, at a input 121, a direct electric current in order to store the electric power and to deliver, at the output 122 thereof, a direct current.

By way of example, the electric power storage device 12 comprises a battery based on an assembly of electrochemical cells and/or a supercapacitor and/or a fuel cell.

The case 11 also contains at least one heater member 13 producing a flow of calories F when an input 131 of the heater member 13 is supplied by an electric voltage, whether it being direct or alternating.

Said at least one heater member 13 can in particular comprise at least one radiating body and/or at least one heat transfer fluid heating device. Such a radiating body can comprise at least one electric resistor intended to be supplied by a direct voltage, for example in the range of 50V. The radiating body can also further comprise one or several resistor(s) intended to be supplied by an alternating voltage, for example 230V, allowing using, in conjunction, the two types of heater sources in order to obtain a point heat effect to compensate for thermal reductions, for example night or day reductions.

The heater member 13 may have thermal inertia characteristics (for example by being formed of soapstone or of cast aluminum, or by incorporating concrete masses or equivalent) to obtain an additional energy storage option.

The heater member 13 can have fast reaction heater characteristics (for example by being equipped with fins or by being of the infrared type) to provide a faster point heat effect.

The heating apparatus 10 may comprise a presence sensor to optimize the point heat effect depending on the needs of the users.

In general, the electric power storage device 12 is intended to be recharged by an electric power supply source 14 external to the apparatus 10. It can typically be the local electrical network.

The electric voltage which supplies said at least one heater member 13 can come indirectly from the electric power supply source 14 by passing through the voltage converter 16 which is described below (in particular in the case where the heater member 13 includes only at least one electric resistor intended to be supplied by direct current) and/or directly from the electric power supply source 14 without passing through the voltage converter 16 (that is to say from the alternating electrical network if the heater member 13 comprises at least one electric resistor intended to be supplied by an alternating current or from a possible direct current renewable energy source if the heater member 13 includes at least one electric resistor intended to be supplied by a direct current) and/or from the output 122 of the electric power storage device 12.

The electric power storage device 12 allows storing the electric power, whether it is intended to be consumed by the heater member 13 or intended to be reinjected to the electric power supply source 14.

In order to be able to ensure such an operation, the case 11 contains first linking elements to allow linking the electric power storage device 12 to the electric power supply source 14.

The first linking elements comprise first connecting elements linking the output 122 of the electric power storage device 12 to the electric power supply source 14, the first connecting elements comprising, very advantageously, an inverter 15 housed in the case 11. An input 151 of the inverter 15 is connected to the output 122 of the electric power storage device 12. An output 152 of the inverter 15 is capable of being linked to the electric power supply source 14.

The case 11 also contains second linking elements to allow linking the input 131 of the heater member 13 to the output 122 of the electric power storage device 12 and third linking elements to allow linking the input 131 of the heater member 13 to the electric power supply source 14.

The first connecting elements comprise first switching elements (not represented) for varying the first connecting elements between an open circuit configuration and a closed circuit configuration in which the electric power stored in the electric power storage device 12 is injected into the electric power supply source 14 via the inverter 15.

Advantageously, the inverter 15 comprises heat sinks producing a second flow of calorie with the calories generated by the inverter 15. The second flow is mixed with the first flow of calories generated by the heater member 13. This allows avoiding heat losses and optimizing the general efficiency of the heating apparatus 10.

In addition to the first connecting elements including the inverter 15, the first linking elements comprise second connecting elements linking an input 121 of the electric power storage device 12 to the electric power supply source 14.

The second connecting elements comprise the voltage converter 16 housed in the case 11 and which comprises an input 161 which can be supplied by the electric power supply source 14 and an output 162 linked to the input 121 of the electric power storage device 12.

The second connecting elements also comprise second switching elements to vary the second connecting elements between an open circuit configuration and a closed circuit configuration in which the electric power coming from the electric power supply source 14 is injected into the electric power storage device 12 via the voltage converter 16.

For example, the voltage converter 16 can be configured so as to be able to deliver, at its output 162, a direct electric voltage capable of supplying the input 121 of the storage device 12 and/or the input 131 of the heater member 13 by conversion of an alternating electric voltage applied to the input 161 of the voltage converter 16 by the electric power supply source 14 when the voltage converter 16 is coupled thereto. Thus, if the electric power supply source is 14 of the type delivering an alternating electric voltage, then the voltage converter 16 could be of the AC/DC type. In addition, the voltage converter 16 could possibly comprise a DC/DC type transformer in the case where the electric power supply source 14, in addition to being capable of delivering an alternating electric voltage, is capable of delivering a direct electric voltage as is the case with alternative energy sources (photovoltaic panels, fuel cells, supercapacitors, batteries based on an assembly of electrochemical cells). It is possible to supply the input 131 of the heater member directly with the alternating electric voltage delivered by the electric power supply source 14.

Typically, the direct voltage level at the output 162 of the voltage converter is comprised between 12 and 600V, which allows locally limiting the safety problems to people in an efficient manner.

In particular, the voltage converter 16 can comprise a switched-mode power supply or chopper type system, which allows avoiding the redundancy between the direct current supplies of the different electronic systems incorporated in the heating apparatus 10 (dedicated board, sensors, display). The switched-mode power supply system can supply all elements of the apparatus 10 with direct current.

In practice, the voltage converter 16 can also be considered as belonging to the third linking elements, the third linking elements comprise linking elements between the output 162 of the voltage converter 16 and the input 131 of the heater member 13. Alternatively or in combination, the third linking elements comprise linking elements directly linking the input 131 of the heater member 13 to the electric power supply source 14, allowing a supply of the electric resistor of the heater member 13 by the electric power supply source in an alternating or direct voltage, without passing through the voltage converter 16. It should be specified that this direct link between the input of the heater member 131 and the electric power supply source 14 comprises a voltage transformer, for example of the AC/AC type, to allow the power of the electrical power supply of the heater member 13 to be regulated.

It should be specified that, in the particular case where the voltage converter 16 is of the AC/DC type, a voltage transformer, in particular of the DC/DC type, is interposed between the output 162 of the voltage converter 16 and, on the one hand, the input 121 of the electric power storage device 12 and, on the other hand, the input 131 of the heater member 13, in order to regulate the power supply voltage of the electric power storage device 12 and/or the heater member 13,

The voltage converter 16 can advantageously comprise heat sinks producing a third flow of calories with the calories generated by the voltage converter 16. The third flow is mixed with the first flow of calories generated by the heater member 13, or even with the second flow generated by the inverter 15. This allows limiting the thermal losses and increasing the efficiency of the apparatus 10.

In a variant promoting the simplicity and limiting the number of general parts, the voltage converter 16 and the inverter 15 are constituted by the same and single bidirectional electrical system.

The heating apparatus 10 allows transforming the assembly necessary for its operation, from an alternating current coming from the power supply source 14 into a direct current thanks to the voltage converter 16 for use in the device 10 directly in continuous form, and transforming, thanks to the inverter 15, the direct current stored in the storage device 12 for use in the power supply source 14 in the form of alternating current. Furthermore, thanks to the voltage converter 16, it is possible to charge the storage device 12, the electric power thus stored within the apparatus 10 being intended to supply the input 131 of the heater member 13 and/or to be reinjected to the power supply source 14 via the inverter 15. It is also possible to address the alternating current coming from the power supply source 14 directly to the input 131 of the heater member 13 and/or to the input 121 of the storage device 12. In other words, the presence of the voltage converter 16 is optional.

The second linking elements comprise third switching elements to vary the second linking elements between a closed circuit configuration and an open circuit configuration. In the closed circuit configuration, the output 122 of the electric power storage device 12 directly supplies the input 131 of the heater member 13, which is not the case in the open circuit configuration.

The third linking elements comprise, in turn, fourth switching elements to vary the third linking elements between a closed circuit configuration and an open circuit configuration. In the closed circuit configuration, the input 131 of the heater member 13 is supplied by the power supply source 14 via the voltage converter 16.

The heating apparatus 10 comprises a management unit 17 housed in the case 11 and controlling at least the heater member 13 and the first switching elements.

The management unit 17 also ensures a control of the second switching elements, the third switching elements and the fourth switching elements.

Via a dedicated intelligence, the management unit 17 can in particular place the heating apparatus 10 selectively in one of the following six modes of operation.

A first mode of operation, in which the fourth switching elements are such that the third linking elements occupy their closed circuit configuration, allows ensuring supplying the heater member 13 by the electric power supply source 14 via the voltage converter 16.

A second mode of operation, in which the third switching elements are such that the second linking elements occupy their closed circuit configuration, allows ensuring an electric power supply of the heater member 13 by the electric power storage device 12.

A third mode of operation, in which the second switching elements are such that the second connecting elements occupy their closed circuit configuration, allows ensuring an electrical charge of the electric power storage device 12 by the electric power supply source 14 via the voltage converter 16 or directly from the electric power supply source 14.

A fourth mode of operation, in which the first switching elements are such that the first connecting elements occupy their closed circuit configuration, allows ensuring the injection of an amount of electric power contained in the electric power storage device 12 to the electric power supply source 14 via the inverter 16.

A fifth mode of operation is such that the heater member 13 is supplied by the electric power supply source 14 at the same time as said electric power supply source is supplied, via the inverter 15, by the electric power storage device 12.

A sixth mode of operation allows ensuring a supply of the heater member 13 directly by the electric power supply source 14 without passing through the voltage converter 16.

The management unit 17 can combine two or several of these six modes at any time.

The previously mentioned intelligence allows selecting the best conditions for choosing between heating by the heater member 13, the direct charge of the electric power storage device 12, the discharge of the electric power storage device 12 to the power supply source 14.

In particular, provision may be made to address an input current 131 of the heater member 13 as soon as the temperature, measured by a dedicated measuring sensor, is lower than a setpoint temperature known to the management unit 17.

Thanks to the voltage converter 16, the voltage and therefore the current in the heater member 13 can vary according to the heater power required for the room.

The current in the heater member 13 can in particular be interrupted as soon as the difference between the room temperature and the setpoint temperature is greater than a predetermined value, for example in the range of 0.3° C., or according to a management algorithm.

The charge of the storage device 12 can be started when an inexpensive power is available or when the state of charge of the storage device 12 becomes lower than a predetermined low threshold, for example in the range of 15%.

The charge of the storage device 12 can be interrupted when the state of charge of the storage device 12 is sufficiently high, in particular by being greater than a high threshold, for example in the range of 95%.

The discharge of the storage device 12 can be controlled when the storage device 12 is sufficiently charged, in particular when its state of charge is greater than an intermediate threshold, for example in the range of 50%, and when no inexpensive power source is available.

In addition, the heating apparatus 10 comprises communication elements, preferably wireless, housed in the case 11 and allowing the management unit 17 to be able to communicate with at least one communicating device of an energy management system of the building in which the heating apparatus 10 is implanted. This allows the previously mentioned intelligence to be directly and easily integrated into the energy management system of the building.

The invention also concerns an electrical installation comprising the electric power supply source 14 delivering an electric voltage and at least one such heating apparatus 10, the output 152 of the inverter 15 of said at least one heating apparatus 10 being linked to the electric power supply source 14.

The use of temperature sensors integrated into the heating apparatus 10 allows a complete knowledge of the building and the habits of the users thereof without adding additional sensors.

The presence of sensors and intelligence allows accurately managing the power consumption and knowing the needs of the building.

Thanks to the use of the storage device 12 and the inverter 15, the electric power can be stored in the heating apparatus 10 then released according to the needs of the building.

Combined with energy generation sources such as solar or wind energy, the heating apparatus 10 can increase the rate of coverage of energy needs by renewable sources and at the same time guarantee a rate of self-consumption of up to 100%.

The communication elements, typically based on low consumption protocols, allow information to be shared with a centralized intelligence of the energy management system.

The dedicated intelligence of the heating apparatus 10 can be provided with machine learning type algorithms allowing maximizing the savings on the entire building by relying on the presence and temperature sensors present over the entire building.

This intelligence allows producing or improving a thermal model of the building representing the main characteristics of this building with a precision corresponding to the level of installation of the heating apparatus 10.

Compared with the produced or improved model, the presence of the sensors also allows detecting the thermal losses or the unusual deviations in order to participate in safety mechanisms, improve the habits of the users and anticipate preventive maintenance on the building.

The integration of the inertia information of the heater member 13 and the point heat effect in the energy management of the building allows improving the self-consumption of the building without reducing the thermal comfort of the users.

Advantageously, this type of energy management system can be integrated within the intelligent networks called «smarts grids» to allow a storage in optimal conditions of renewable and continuous energies on the electrical network.

Advantageously, the management unit 17 of the heating apparatus 10 can be controlled subsequently to the events of the domestic network or the national network to compensate for the following cases encountered in «smarts grids»: surplus production relative to the demand, surplus demand relative to the production and withdrawal of reactive power.

In the case of production greater than demand, the storage device 12 can consume energy on the domestic or national network for local storage.

In the case of demand greater than production, the storage device 12 can supply power to the domestic or national network.

In case of withdrawal of reactive power, the storage device 12 can be used, with the appropriate voltage and phase parameters, in order to increase the power factor and/or reduce the harmonic pollution of the network.

The sources of solar energy, fuel cells, supercapacitors and electrochemical batteries are direct voltage sources which can be partially integrated into the electric power supply source 14 which supplies the heating apparatus 10. These direct voltage sources generally having significant voltage levels, the DC/DC type voltage converter 16 then allows a use in the heating apparatus 10 under optimal conditions.

The lighting, air conditioning and domestic hot water can be integrated with the central intelligence in order to allow the other elements of the building to participate in the energy management.

The use in the housing of a cogeneration boiler can advantageously provide an additional source of electricity for recharging the batteries. Thus, the system comprising the previously described electrical installation and a cogeneration boiler ensures that all electricity produced by the boiler is effectively self-consumed.

1. An electrical radiator type heating apparatus having a case containing an electric power storage device, first linking elements linking the electric power storage device to an electric power supply source external to the apparatus, at least one heater member producing a flow of calories when an input of the heater member is supplied by an electric voltage, second linking elements linking the input of the heater member to an output of the electric power storage device and third linking elements linking the input of the heater member to the electric power supply source, wherein the first linking elements comprise first connecting elements linking the output of the electric power storage device to the electric power supply source, the first connecting elements comprising:
an inverter housed in the case, an input of the inverter is connected to the output of the electric power storage device and an output of the inverter is capable of being linked to the electric power supply source,
and first switching elements to vary the first connecting elements between an open circuit configuration and a closed circuit configuration in which the electric power stored in the electric power storage device is injected into the electric power supply source via the inverter.

2. The heating apparatus according to claim 1, wherein the inverter comprises heat sinks producing a second flow of calorie with the calories generated by the inverter and in that the second flow is mixed with the first flow of calories generated by the heater member.

3. The heating apparatus according to claim 1, wherein the first linking elements comprise second connecting elements linking an input of the electric power storage device to the electric power supply source, the second connecting elements comprising:
a voltage converter housed in the case and having an input supplied by the electric power supply source and an output linked to the input of the electric power storage device,
and second switching elements to vary the second connecting elements between an open circuit configuration and a closed circuit configuration in which the electric power from the electric power supply source is injected into the electric power storage device via the voltage converter.

4. The heating apparatus according to claim 3, wherein the voltage converter comprises heat sinks producing a third flow of calories with the calories generated by the voltage converter and in that the third flow is mixed with the first flow of calories generated by the heater member.

5. The heating apparatus according to claim 3, wherein the voltage converter and the inverter are constituted by the same and single bidirectional electrical system.

6. The heating apparatus according to claim 3, wherein the third linking elements comprise linking elements between the output of the voltage converter and the input of the heater member.

7. The heating apparatus according to claim 1, wherein it comprises a management unit housed in the case and controlling at least the heater member and the first switching elements and/or linking elements directly linking the input of the heater member to the electric power supply source.

8. The heating apparatus according to claim 7, wherein the management unit ensures a control of the second switching elements, third switching elements to vary the second linking elements between a closed circuit configuration and an open circuit configuration, and fourth switching elements to vary the third linking elements between a closed circuit configuration and an open circuit configuration.

9. The heating apparatus according to claim 7, wherein it comprises communication elements housed in the case allowing the management unit to be able to communicate with at least one communicating device of an energy management system of the building in which the heating apparatus is implanted.

10. An electrical installation comprising an electric power supply source delivering an electric voltage and at least one heating apparatus according to claim 1, the output of the inverter of the at least one heating apparatus being linked to the electric power supply source.

11. The heating apparatus according to claim 2, wherein the first linking elements comprise second connecting elements linking an input of the electric power storage device to the electric power supply source, the second connecting elements comprising:
a voltage converter housed in the case and having an input supplied by the electric power supply source and an output linked to the input of the electric power storage device,
and second switching elements to vary the second connecting elements between an open circuit configuration and a closed circuit configuration in which the electric power from the electric power supply source is injected into the electric power storage device via the voltage converter.

12. The heating apparatus according to claim 11, wherein the voltage converter comprises heat sinks producing a third flow of calories with the calories generated by the voltage converter and in that the third flow is mixed with the first flow of calories generated by the heater member.

13. The heating apparatus according to claim 12, wherein the voltage converter and the inverter are constituted by the same and single bidirectional electrical system.

14. The heating apparatus according to claim 13, wherein the third linking elements comprise linking elements between the output of the voltage converter and the input of the heater member.

15. The heating apparatus according to claim 14, wherein it comprises a management unit housed in the case and controlling at least the heater member and the first switching elements and/or linking elements directly linking the input of the heater member to the electric power supply source.

16. The heating apparatus according to claim 15, wherein the management unit ensures a control of the second switching elements, third switching elements to vary the second linking elements between a closed circuit configuration and an open circuit configuration, and fourth switching elements to vary the third linking elements between a closed circuit configuration and an open circuit configuration.

17. The heating apparatus according to claim 16, wherein it comprises communication elements housed in the case allowing the management unit to be able to communicate with at least one communicating device of an energy management system of the building in which the heating apparatus is implanted.

18. The heating apparatus according to claim 4, wherein the voltage converter and the inverter are constituted by the same and single bidirectional electrical system.

19. The heating apparatus according to claim 4, wherein the third linking elements comprise linking elements between the output of the voltage converter and the input of the heater member.

20. The heating apparatus according to claim 5, wherein the third linking elements comprise linking elements between the output of the voltage converter and the input of the heater member.
